(19) United States
(12) Patent Application Publication
(10) Pub. No.: US 2011/0157269 A1
(43) Pub. Date: Jun. 30, 2011

(54) LIQUID DISCHARGING APPARATUS AND LIQUID DISCHARGING METHOD

(75) Inventor: Hirofumi Teramae, Matsumoto-shi (JP)

(73) Assignee: Seiko Epson Corporaton, Tokyo (JP)

(21) Appl. No.: 12/980,722

(22) Filed: Dec. 29, 2010

(30) Foreign Application Priority Data
Dec. 29, 2009 (JP) 2009-299047

(51) Int. Cl. B41J 29/38

(52) U.S. Cl. 347/14

(57) ABSTRACT

An apparatus includes a mechanism that transports a medium in a transportation direction; nozzle lines each composed of nozzles aligned in the transportation direction, the nozzle lines arranged adjacent to one another in a movement direction orthogonal to the transportation direction; a mechanism that moves the nozzle lines in the movement direction; and a controller for repeating operation of discharging liquid from each nozzle line being moved bi-directionally during outward and homeward movement and operation of transporting the medium in a period between the outward and homeward discharging operation by transportation amount corresponding to nozzle-line length. When a line is printed along the transportation direction using a certain nozzle line in a certain liquid discharging operation, timing of discharging the liquid therefrom is corrected in accordance with duty of printing performed using another, other, or the other nozzle line(s) located downstream of the certain nozzle line in the movement direction.

### CROSS REFERENCES TO RELATED APPLICATIONS

The present invention contains subject matter related to Japanese Patent Application No. 2009-299047 filed in the Japanese Patent Office on Dec. 29, 2009, the entire contents of which are incorporated herein by reference.

### BACKGROUND

1. Technical Field

The present invention relates to a liquid discharging apparatus and a liquid discharging method.

2. Related Art

A serial ink-jet printer that alternately repeats operation of transporting a print target medium (e.g., paper) and operation of discharging liquid (e.g., ink) from a head while moving the head is known as an example of various liquid discharging apparatuses. Cockling sometimes occurs when an image or the like is formed on a sheet of paper by discharging ink droplets onto the surface thereof by using such a printer. Cockling is a phenomenon of sheet corrugation due to the swelling of paper, which occurs when the paper absorbs a large amount of ink. When cockling occurs, the clearance between a head and a sheet of paper becomes irregular due to undulations of the paper, which makes the distance of movement of an ink droplet in the air irregular. For this reason, there is a problem in that a shift occurs in the landing position of ink, that is, a position where a discharged ink droplet lands on the surface of a paper. To address such a problem, a printer having the following features has been proposed in the art as disclosed in, for example, JP-A-2003-246524. The printer includes a platen that has a plurality of projections. A plurality of suction holes is formed in the top of the projections and a bottom surface between the projections. A force of suction generated by a suction pump or the like is applied to paper through the suction holes so as to vacuum chuck the paper therealong for transportation. By this means, the disclosed printer suppresses cockling, thereby reducing a shift in the landing position of ink.

As will be explained later, a shift in the landing position of ink due to cockling is conspicuous at the junction of one part of a ruled line and the other part thereof when the ruled line is printed along the direction of transportation of paper by means of a bidirectional band printing method. Specifically, a shift in position at the junction of one part of a ruled line that is drawn during outward movement and the other part thereof that is drawn during homeward movement is especially conspicuous. Though it is conceivable to provide a sucking means as described above for suppressing cockling, such a solution has a disadvantage in that noise is generated during sucking operation. It has another disadvantage of increased cost.

### SUMMARY

An advantage of some aspects of the invention is to provide a technique for reducing a shift in position at the junction of a ruled line without recourse to sucking.

To offer the above advantage without any limitation thereto, a liquid discharging apparatus having the following features are provided as a main aspect of the invention. The apparatus includes a transporting mechanism that transports a target medium in a transportation direction; a plurality of nozzle lines each of which is made up of a plurality of nozzles aligned in the transportation direction, the plurality of nozzle lines being arranged adjacent to one another in a movement direction orthogonal to the transportation direction; a moving mechanism that moves the plurality of nozzle lines in the movement direction; and a controller for repeating operation of discharging liquid from each of the nozzle lines that are being moved bi-directionally by the moving mechanism during outward and homeward movement in the movement direction and operation of transporting the target medium by the transporting mechanism in the transportation direction in a period between the outward and homeward liquid discharging operation by transportation amount corresponding to the length of a nozzle line. When a ruled line is printed along the transportation direction with the use of a certain nozzle line in a certain liquid discharging operation, timing of discharging the liquid from the certain nozzle line in the certain liquid discharging operation is corrected in accordance with duty of printing performed with the use of another nozzle line or other or the other nozzle lines located at a downstream side with respect to the certain nozzle line in the movement direction. Other features and advantages offered by the invention will be fully understood by referring to the following detailed description in conjunction with the accompanying drawings.

### BRIEF DESCRIPTION OF THE DRAWINGS

The invention will be described with reference to the accompanying drawings, wherein like numbers reference like elements.

FIG. 1 is a perspective view that schematically illustrates an example of the general appearance of a printing system according to an exemplary embodiment of the invention.

FIG. 2 is a block diagram that schematically illustrates an example of the overall configuration of a printer according to an exemplary embodiment of the invention.

FIG. 3 is a perspective view that schematically illustrates an example of the general appearance of the printer according to an exemplary embodiment of the invention.

FIG. 4 is a side sectional view that schematically illustrates an example of the configuration of the printer according to an exemplary embodiment of the invention.

FIG. 5 is a flowchart that schematically illustrates an example of the flow of printing.

FIG. 6 is a diagram that schematically illustrates an example of the arrangement of nozzles formed in the bottom surface of a head.

FIG. 7 is a diagram that schematically illustrates an example of the configuration of a head unit.

FIG. 8 is a timing chart of signals.

FIG. 9A illustrates an example of a band printing method.

FIG. 9B illustrates an example of a band printing method.

FIG. 10 is a diagram that schematically illustrates an example of the direction of outward movement of a carriage and the direction of homeward movement of the carriage.

FIG. 11 is a diagram that schematically illustrates an example of the ink-discharging timing of the head during outward and homeward movement.

FIG. 12 is a diagram that schematically illustrates an example of borderless printing.

FIG. 13A is a diagram that schematically illustrates an example of the discharging of ink when borderless printing is performed.

FIG. 13B is a diagram that schematically illustrates an example of the landing of the discharged ink when borderless printing is performed.

FIG. 14 is a diagram that schematically illustrates an example of the states of paper when a cockling phenomenon has occurred.

FIG. 15 is a diagram that schematically illustrates Bi-d correction according to a comparative example.

FIG. 16 is a diagram that schematically illustrates an example of Bi-d correction according to an exemplary embodiment of the invention.

FIG. 17 is a flowchart that schematically illustrates an example of the flow of processing for printing according to a first embodiment of the invention.

FIG. 18 is a flowchart that schematically illustrates an example of the flow of processing for printing according to a second embodiment of the invention.

### DESCRIPTION OF EXEMPLARY EMBODIMENTS

A person skilled in the art will fully understand at least the following novel and inventive concept of the invention through reading the detailed description of this specification with reference to accompanying drawings.

A liquid discharging apparatus according to a first aspect of the invention includes a transporting mechanism, a plurality of nozzle lines, a moving mechanism, and a controller. The transporting mechanism transports a target medium in a transportation direction. Each of the plurality of nozzle lines is made up of a plurality of nozzles aligned in the transportation direction. The plurality of nozzle lines is arranged adjacent to one another in a movement direction orthogonal to the transportation direction. The moving mechanism moves the plurality of nozzle lines in the movement direction. The controller performs control processing for repeating liquid discharging operation and transporting operation. The liquid discharging operation is operation for discharging liquid from each of the nozzle lines that are being moved bi-directionally by the moving mechanism during outward and homeward movement in the movement direction. The transporting operation is operation for transporting the target medium by the transporting mechanism in the transportation direction in a period between the outward and homeward liquid discharging operation by transportation amount corresponding to the length of a nozzle line. When a ruled line is printed along the transportation direction with the use of a certain nozzle line in a certain liquid discharging operation, timing of discharging the liquid from the certain nozzle line in the certain liquid discharging operation is corrected in accordance with duty of printing performed with the use of another nozzle line or other or the other nozzle lines located at a downstream side with respect to the certain nozzle line in the movement direction. The liquid discharging apparatus makes it possible to reduce a shift in position at the junction of a ruled line in outward and homeward movement.

It is preferable that the liquid discharging apparatus should further include a plurality of supporting members that is arranged in the movement direction for supporting the target medium during transportation, wherein the controller corrects the timing of discharging the liquid to ensure that a positional difference between a position where the liquid discharged in the liquid discharging operation during the outward movement and a position where the liquid discharged in the liquid discharging operation during the homeward movement is minimized at a midpoint between the center of an area between the neighboring supporting members and an end of the area in the movement direction. The liquid discharging apparatus having such a preferred configuration makes it possible to make a shift in position between dots formed during outward movement and dots formed during homeward movement inconspicuous.

A liquid discharging apparatus according to a second aspect of the invention includes a transporting mechanism, a plurality of nozzle lines, a moving mechanism, a plurality of supporting members, and a controller. The transporting mechanism transports a target medium in a transportation direction. Each of the plurality of nozzle lines is made up of a plurality of nozzles aligned in the transportation direction. The plurality of nozzle lines is arranged adjacent to one another in a movement direction orthogonal to the transportation direction. The moving mechanism moves the plurality of nozzle lines in the movement direction. The plurality of supporting members is arranged in the movement direction for supporting the target medium during transportation. The controller performs control processing for repeating liquid discharging operation and transporting operation. The liquid discharging operation is operation for discharging liquid from each of the nozzle lines that are being moved bi-directionally by the moving mechanism during outward and homeward movement in the movement direction. The transporting operation is operation for transporting the target medium by the transporting mechanism in the transportation direction in a period between the outward and homeward liquid discharging operation by transportation amount corresponding to the length of a nozzle line. When a ruled line is printed along the transportation direction with the use of a certain nozzle line in a certain liquid discharging operation, timing of discharging the liquid from the certain nozzle line in the certain liquid discharging operation is corrected in accordance with duty of printing performed at an area between the supporting members where the ruled line is to be located with the use of another nozzle line or other or the other nozzle lines located at a downstream side with respect to the certain nozzle line in the movement direction.

Preferably, in the liquid discharging apparatus according to the second aspect of the invention, the controller should correct the timing of discharging the liquid to ensure that a positional difference between a position where the liquid discharged in the liquid discharging operation during the outward movement and a position where the liquid discharged in the liquid discharging operation during the homeward movement is minimized at a midpoint between the center and an end of the area in the movement direction. The liquid discharging apparatus having such a preferred configuration makes it possible to make a shift in position between dots formed during outward movement and dots formed during homeward movement inconspicuous.

A liquid discharging method according to a third aspect of the invention has the following features. A target medium is transported in a transportation direction. Each of a plurality of nozzle lines is made up of a plurality of nozzles aligned in the transportation direction. The plurality of nozzle lines is arranged adjacent to one another in a movement direction orthogonal to the transportation direction. The plurality of nozzle lines is moved in the movement direction. Liquid discharging operation and transporting operation are repeated. The liquid discharging operation is operation for discharging liquid from each of the nozzle lines that are being moved bi-directionally during outward and homeward movement in the movement direction. The transporting operation is operation for transporting the target medium in the transportation direction in a period between the outward and homeward liquid discharging operation by transportation amount corresponding to the length of a nozzle line. When a ruled line is printed along the transportation direction with the use of a certain nozzle line in a certain liquid discharging operation, timing of discharging the liquid from the certain nozzle line in the certain liquid discharging operation is corrected in accordance with duty of printing performed with the use of another nozzle line or other or the other nozzle lines located at a downstream side with respect to the certain nozzle line in the movement direction.

A liquid discharging method according to a fourth aspect of the invention has the following features. A target medium is transported in a transportation direction. Each of a plurality of nozzle lines is made up of a plurality of nozzles aligned in the transportation direction. The plurality of nozzle lines is arranged adjacent to one another in a movement direction orthogonal to the transportation direction. The plurality of nozzle lines is moved in the movement direction. A plurality of supporting members is arranged in the movement direction for supporting the target medium during transportation. Liquid discharging operation and transporting operation are repeated. The liquid discharging operation is operation for discharging liquid from each of the nozzle lines that are being moved bi-directionally during outward and homeward movement in the movement direction. The transporting operation is operation for transporting the target medium in the transportation direction in a period between the outward and homeward liquid discharging operation by transportation amount corresponding to the length of a nozzle line. When a ruled line is printed along the transportation direction with the use of a certain nozzle line in a certain liquid discharging operation, timing of discharging the liquid from the certain nozzle line in the certain liquid discharging operation is corrected in accordance with duty of printing performed at an area between the supporting members where the ruled line is to be located with the use of another nozzle line or other or the other nozzle lines located at a downstream side with respect to the certain nozzle line in the movement direction.

In the following description of exemplary embodiments, an ink-jet printer (hereinafter may be referred to as printer) is taken as an example of a liquid discharging apparatus.

### First Embodiment

### Configuration of Printing System

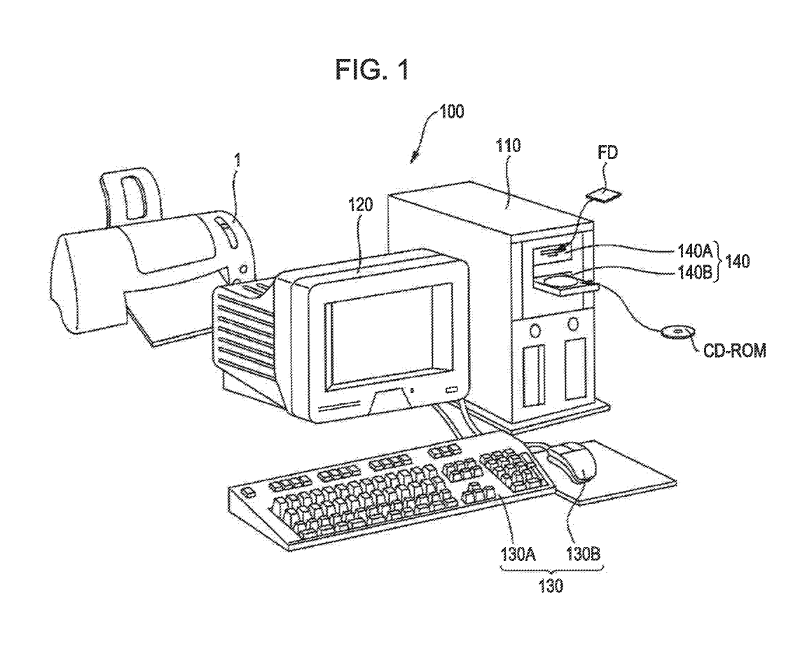

First of all, with reference to the accompanying drawings, the configuration of a printing system will now be explained. FIG. 1 is a perspective view that schematically illustrates an example of the general appearance of a printing system according to an exemplary embodiment of the invention. A printing system 100 includes a printer 1, a computer 110, a display device 120, an input device 130, and a recording/reproduction device 140. The printer 1 is an apparatus (printing apparatus) that prints an image on a target medium such as a sheet of printing paper, cloth, film, or the like. The computer 110 is electrically connected to the printer 1. The computer 110 outputs, to the printer 1, print data corresponding to an image that is to be printed out, thereby causing the printer 1 to perform printing. The display device 120 has a display screen. The display device 120 displays an application program, user interface such as, for example, a printer driver, and the like on its screen. Examples of the input device 130 are a keyboard 130A and a computer mouse 130B. A user can perform input operation by using the input device 130 to, for example, give instructions to an application program and set a printer driver in accordance with user interface displayed on the screen of the display device 120. The recording/reproduction device 140 is a write/read unit. For example, a flexible disk drive unit 140A and a CD-ROM drive unit 140B are used as the recording/reproduction device 140.

A printer driver is installed in the computer 110. The printer driver is a program that has a function of causing the display device 120 to display user interface and a function of converting image data outputted from an application program into print data. The printer driver is stored in a storage medium (computer readable storage medium) such as a flexible disk (FD), a CD-ROM, or the like. The printer driver may be downloaded into the computer 110 via the Internet. The program is composed of codes for implementing various functions. The term “printing apparatus” refers to the printer 1 in a narrow sense. In a broad sense of the term, it refers to a system that includes the printer 1 and the computer 110.

### Configuration of Ink-jet Printer

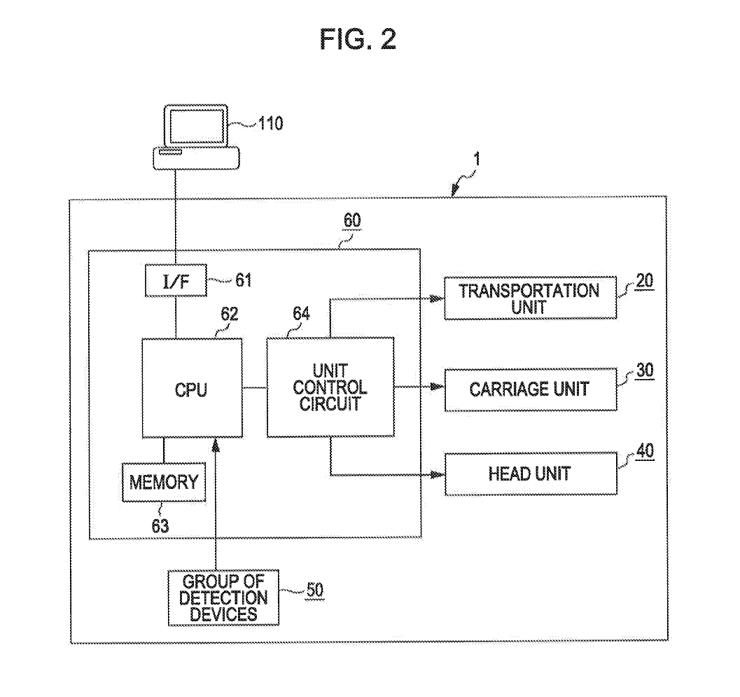

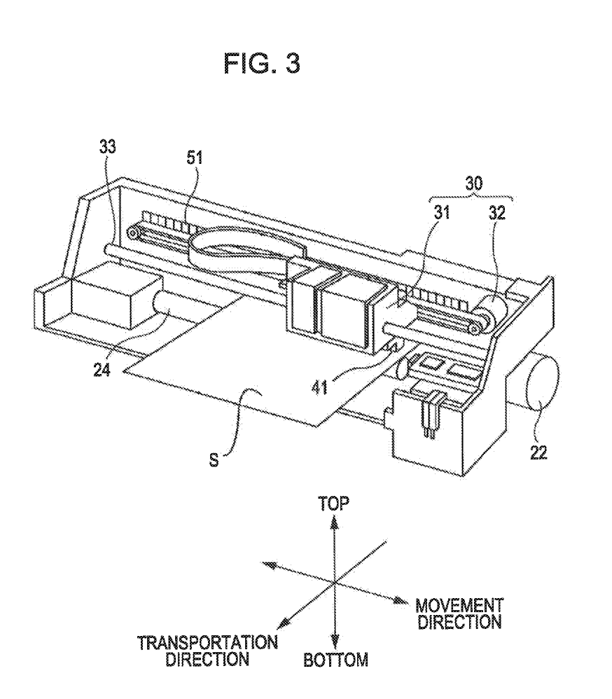

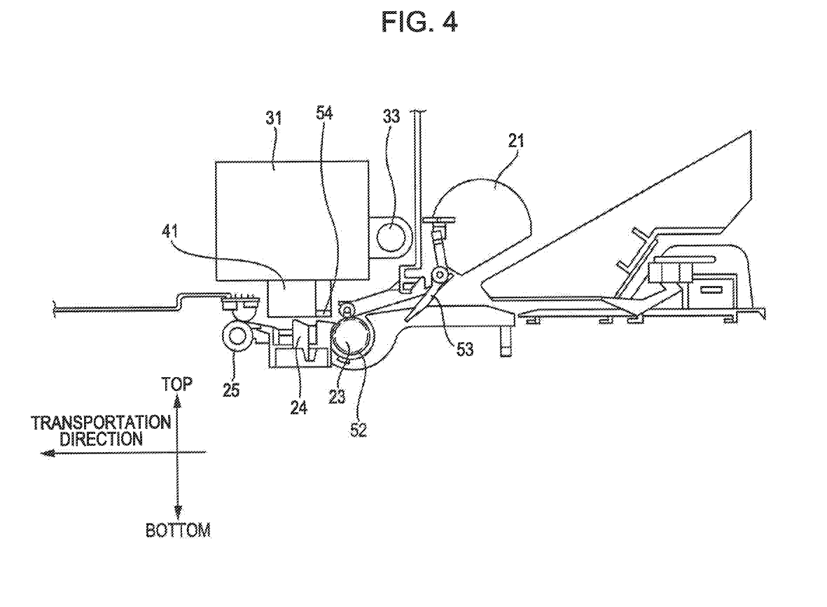

FIG. 2 is a block diagram that schematically illustrates an example of the overall configuration of the printer 1 according to the present embodiment of the invention. FIG. 3 is a perspective view that schematically illustrates an example of the general appearance of the printer 1 according to the present embodiment of the invention. FIG. 4 is a side sectional view that schematically illustrates an example of the configuration of the printer 1 according to the present embodiment of the invention. The basic configuration of a printer according to the present embodiment of the invention is explained below.

The printer 1 includes a medium transportation unit 20, a carriage unit 30, a head unit 40, a group of detection devices 50, and a controller 60. The printer 1 receives print data from the computer 110, which is an external device. Upon receiving the print data, the controller 60 controls the medium transportation unit 20, the carriage unit 30, and the head unit 40 to form an image on, for example, a sheet of printing paper. The group of detection devices 50 monitors the internal operation state of the printer 1. The group of detection devices 50 outputs the result of detection to the controller 60. On the basis of the result of detection outputted from the group of detection devices 50, the controller 60 controls each of the units 20, 30, and 40.

The medium transportation unit 20 (which corresponds to a transporting mechanism) is a unit that transports a print target medium (e.g., a sheet of paper S) in a predetermined direction (hereinafter referred to as “transportation direction). The transportation unit 20 includes a paper-feed roller 21, a transportation motor (which is also known as “PF motor”) 22, a transportation roller 23, a platen 24, and a paper-eject roller 25. The paper-feed roller 21 is a roller that feeds sheets of paper S inserted in a paper insertion port sequentially into the printer 1. The transportation roller 23 is a roller that transports a sheet of paper S fed by the paper-feed roller 21 to an area where an image or the like can be printed thereon. The transportation roller 23 rotates when driven by the transportation motor 22. The platen 24 supports the sheet of paper S during printing. As will be described later, the platen 24 according to the present embodiment of the invention includes projection portions and recess portions. The paper-eject roller 25 is a roller that ejects the sheet of paper S out of the printer 1. The paper-eject roller 25 is provided downstream of the area where printing can be performed on the sheet of paper S in the transportation direction.

The carriage unit 30 (which corresponds to a moving mechanism) causes a head to move in a predetermined direction (hereinafter referred to as “movement direction”). The movement of the head is called as scan operation. The carriage unit 30 includes a carriage 31 and a carriage motor (which is also known as “CR motor”) 32. The carriage 31 can reciprocate in the movement direction. The carriage 31 moves when driven by the carriage motor 32. A plurality of ink cartridges that contains ink (which is a kind of liquid) is mounted on the carriage 31. The carriage motor 32 is a motor that supplies power for moving the carriage 31 in the movement direction. The carriage motor 32 is a DC motor. A carriage shaft (which is also known as guiding shaft) 33 supports the carriage 31. The carriage shaft 33 extends in the direction orthogonal to the transportation direction. The carriage 31 reciprocates along the carriage shaft 33 when driven by the carriage motor 32.

The head unit 40 discharges ink in the form of droplets onto a sheet of paper S. The head unit 40 includes a head 41. The head 41 has a plurality of nozzles. Since the head unit 40 is mounted on the carriage 31, the head unit 40 travels in the movement direction when the carriage 31 travels in the movement direction. Ink droplets are discharged intermittently during the traveling of the head 41 in the movement direction. As a result, a dot line (raster line) is formed on a sheet of paper S along the movement direction. A more detailed explanation of the head unit 40 will be given later.

The group of detection devices 50 includes a linear encoder 51, a rotary encoder 52, a paper detection sensor 53, an optical sensor 54, and the like. The linear encoder 51 detects the position of the carriage 31 in the movement direction. The rotary encoder 52 detects the amount of rotation of the transportation roller 23. The paper detection sensor 53 detects the position of the leading edge of a sheet of paper S during the feeding thereof. The optical sensor 54 includes a light emission unit and a light reception unit. These units are mounted on the carriage 31. The optical sensor 54 detects the presence/absence of a sheet of paper S. While being moved together with the carriage 31, the optical sensor 54 can detect the positions of left and right edges of the sheet of paper S to obtain information on the width thereof. In addition, as may be necessary, the optical sensor 54 can detect the leading edge of the sheet S (which is the downstream-side edge in the transportation direction and may be referred to as top edge) and the rear edge of the sheet S (which is the upstream-side edge in the transportation direction and may be referred to as bottom edge).

The controller 60 is a unit that controls the operation of the printer 1. The controller 60 includes an interface 61, a CPU 62, a memory 63, and a unit control circuit 64. The interface 61 is used for performing data transmission/reception between the computer 110, which is an external device, and the printer 1. The CPU 62 is a central processing unit that performs arithmetic processing for controlling the entire operation of the printer 1. The memory 63 provides a memory area for storing programs, a work area, and the like for the operation of the CPU 62. The memory 63 includes a storage element such as RAM, EEPROM, or the like. In accordance with a program that is stored in the memory 63, the CPU 62 controls each of the units 20, 30, and 40 through the unit control circuit 64.

### Printing Procedure

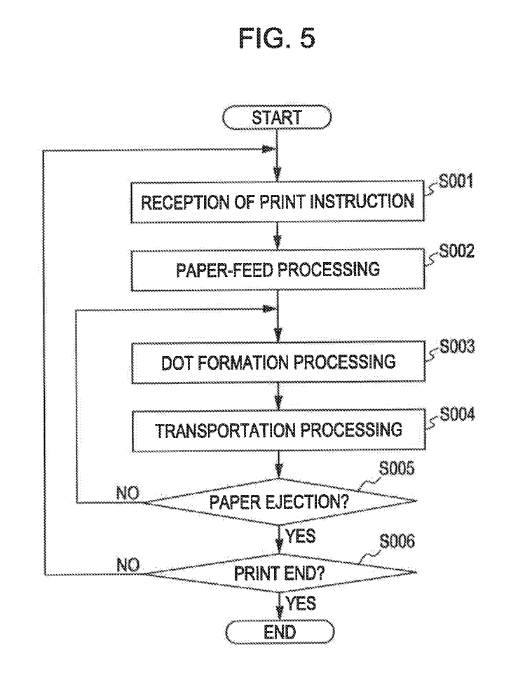

FIG. 5 is a flowchart that schematically illustrates an example of the flow of printing. Each processing of the following procedure is performed when the controller 60 controls the relevant unit(s) in accordance with the program stored in the memory 63. The program includes codes for carrying out each of the following series of operations.

The controller 60 receives an instruction for printing from the computer 110 through the interface 61 (S001). The print instruction is contained in the header of print data transmitted from the computer 110. Upon receiving the print instruction, the controller 60 analyzes the content of various commands contained in the received print data and performs paper-feed processing, transportation processing, ink-discharging processing, and the like as explained below by means of the relevant unit(s).

The controller 60 performs control processing for paper-feed operation first (S002). The term “target-feed processing” (target-feed operation, the same applies hereinafter) means the feeding of a target medium, for example, a sheet of paper on which an image is to be printed, into the printer 1 to determine the position of the target medium at a print start position (i.e., “print-ready position”). The controller 60 causes the paper-feed roller 21 to rotate so as to feed a sheet of printing paper to the transportation roller 23. The controller 60 causes the transportation roller 23 to rotate so as to set the sheet of paper fed from the paper-feed roller 21 at the print start position. When the sheet of paper has been set at the print start position, at least some nozzles of the head 41 face the sheet of paper.

Next, the controller 60 performs control processing for dot formation operation (S003). The term “dot formation processing” means the discharging of liquid such as ink intermittently from the head 41 that is traveling in the movement direction to form dots on a target medium. The controller 60 drives the carriage motor 32 to move the carriage 31 in the movement direction. The controller 60 causes the head 41 to discharge ink on the basis of the print data during the traveling of the carriage 31. Dots are formed on the surface of the printing paper as a result of the landing of ink droplets discharged from the head 41.

Next, the controller 60 performs control processing for transportation operation (S004). The term “transportation processing” means the moving of a target medium such as paper relative to the head 41 in the transportation direction. The controller 60 drives the transportation motor 22 to rotate the transportation roller 23, thereby transporting the sheet of paper in the transportation direction. After the above transportation processing, the head 41 can form dots at positions that are different from positions where dots were formed during preceding/previous dot formation processing.

Next, the controller 60 judges whether the sheet of paper on which printing is currently being performed should be ejected or not (S005). If there is any data that should be printed on the sheet of paper that is currently being processed for printing but has not been printed thereon yet, ejection processing is not performed at this point in time. The controller 60 performs control processing for repeating the above dot formation operation and the above transportation operation alternately until there remains no data that has not been printed thereon yet. In this way, an image that is made up of dots is printed on the sheet of paper through the multiple alternations. When no data that has not been printed yet on the currently processed sheet of paper is left, the controller 60 performs control processing for paper ejection. Specifically, the controller 60 causes the paper-eject roller 25 to rotate so as to eject the print-completed paper to the outside. Alternatively, it may be judged whether the paper should be elected or not on the basis of an ejection command.

Next, the controller 60 judges whether the print processing should be continued or not (S006). If printing should be performed on the next sheet of paper, the ongoing print job is continued. In such a case, the controller 60 performs control processing for starting the feeding of the next sheet of paper for continued printing. If not, the controller 60 terminates the print operation.

### Head 41

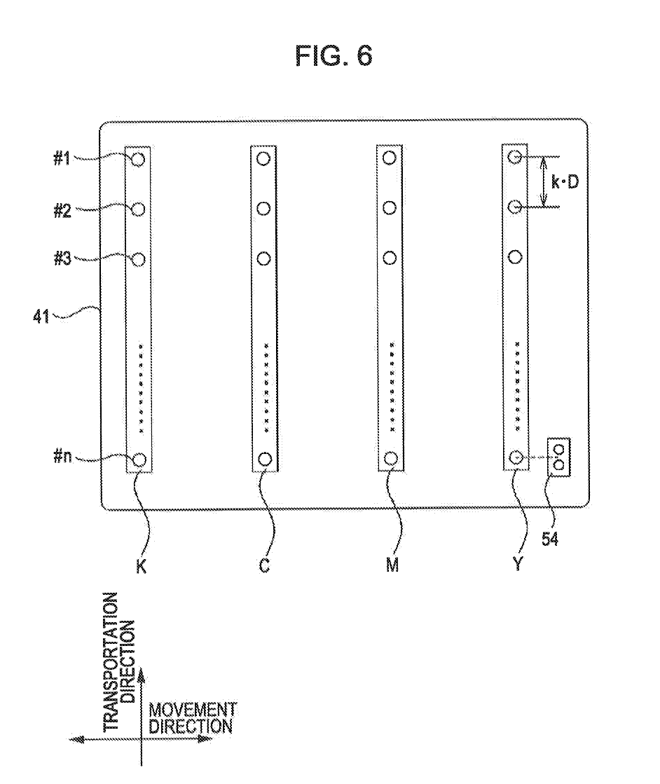

FIG. 6 is a diagram that schematically illustrates an example of the arrangement of nozzles formed in the bottom surface of the head 41. As illustrated in FIG. 6, a black ink nozzle line K, a cyan ink nozzle line C, a magenta ink nozzle line M, and a yellow ink nozzle line Y are arranged adjacent to one another in the movement direction in the bottom surface of the head 41. Each of the above nozzle lines is made up of a plurality of nozzles. Each of the plurality of nozzles functions as an ink-discharging hole. In the present embodiment of the invention, one hundred eighty nozzles make up each of the above nozzle lines. Ink of the corresponding color is discharged from each of the nozzle lines.

The plurality of nozzles is aligned at certain intervals (i.e., nozzle pitch: k·D) in the transportation direction to form each of the nozzle lines. In the above nozzle pitch k·D, the symbol D denotes the minimum dot pitch in the transportation direction (i.e., the interval at the maximum resolution of dots formed on a sheet of paper S). In addition, k is an integer that is not smaller than one. For example, let the pitch of nozzles be 180 dpi (1/180 inch). In addition, let the pitch of dots be 720 dpi (1/720 inch). In this example, k is equal to four.

In each of the above nozzle lines, nozzles are numbered in ascending order from the downstream side to the upstream side (#1 to #180). That is, the nozzle #1 is located downstream of the nozzle #180 in the transportation direction. As an example of a driving element, which performs driving operation for discharging ink droplets from a nozzle, a piezoelectric element is provided for each of the plurality of nozzles. The piezoelectric element is not illustrated in the drawing. The optical sensor 54 is provided at the same position in the transportation direction as that of the nozzle #180, that is, the first nozzle from the upstream end of the nozzle line. Driving of Head 41

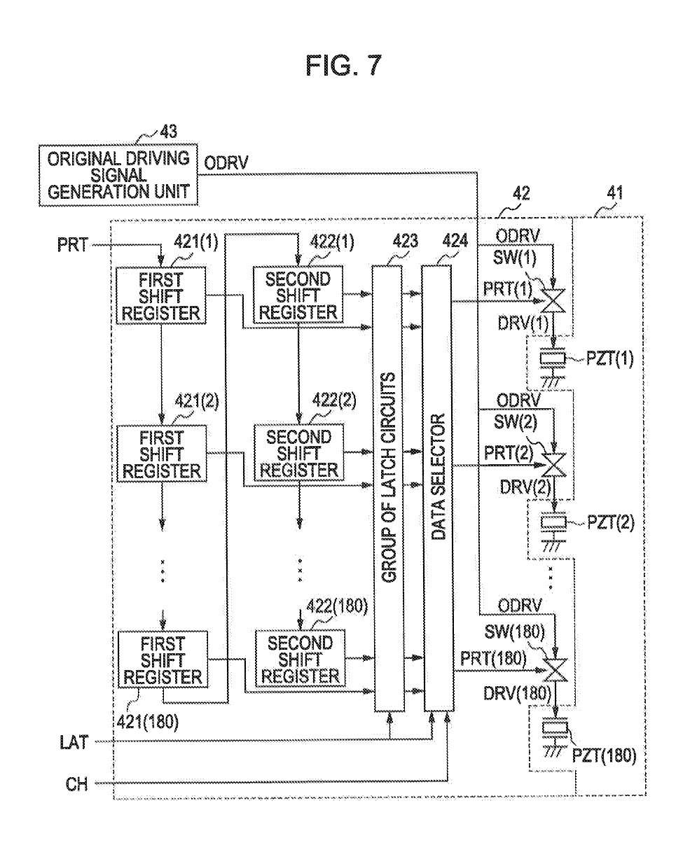

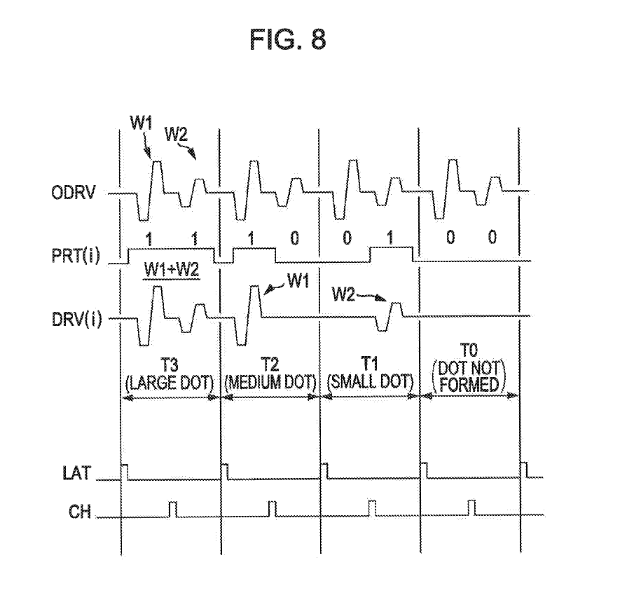

FIG. 7 is a diagram that schematically illustrates an example of the configuration of the head unit 40. FIG. 8 is a timing chart of signals.

Besides the head 41, the head unit 40 includes a head driving circuit 42 and an original driving signal generation unit 43. The head driving circuit 42 drives the head 41. The original driving signal generation unit 43 generates an original driving signal ODRV. The head 41, which has the nozzle lines for respective colors as explained above, includes a plurality of piezoelectric elements PZT, the number of which corresponds to the number of nozzles, and a plurality of pressure chambers (not shown) each of which is formed for the corresponding one of the plurality of piezoelectric elements PZT.

The head driving circuit 42 includes one hundred eighty first shift registers 421, one hundred eighty second shift registers 422, a group of latch circuits 423, a data selector 424, and one hundred eighty switches SW. In FIG. 7, each numeral in a parenthesis indicates the ordinal number of the nozzle to which the member/component (or signal) corresponds. The head driving circuit 42 drives each of the one hundred eighty piezoelectric elements PZT on the basis of a print signal PRT, which is transferred in serial, to discharge ink droplets from the corresponding nozzle. The head driving circuit 42 is provided for each of the nozzle lines for respective colors.

The original driving signal ODRV is supplied as a signal common to the one hundred eighty piezoelectric elements PZT. The original driving signal ODRV has two driving pulses, which are a first pulse W1 and a second pulse W2, in a unit period of time in which a nozzle passes across one pixel. The original driving signal ODRV is supplied from the original driving signal generation unit 43, which is provided in the body of the printer 1, to each of the switches SW of the head driving circuit 42 through a cable.

A print signal PRT(i) is a signal that corresponds to pixel data assigned to one pixel for which the nozzle #i is used for printing. In the present embodiment of the invention, the print signal PRT(i) contains 2-bit information for one pixel. The print signal PRT(i) is sent from the data selector 424 to the corresponding switch SW(i).

The print signal PRT is a signal for serially transferring the plurality of print signals PRT(i, 1-180), the number of which corresponds to the number of nozzles. The serial print signal PRT is inputted into the head driving circuit 42 and then converted into the one hundred eighty 2-bit parallel print signals PRT(i). The serial-to-parallel conversion will be explained later.

A driving signal DRV(i) is a signal for driving a piezoelectric element PZT(i), which is provided for the corresponding nozzle #i. When the driving signal DRV(i) is supplied as an input to the piezoelectric element PZT(i), the piezoelectric element PZT(i) becomes deformed in accordance with a change in the voltage of the driving signal DRV(i). As the piezoelectric element PZT(i) becomes deformed, an elastic membrane that is provided as a part (a sidewall) of the corresponding pressure chamber becomes deformed. As a result, ink retained in the pressure chamber is discharged through the nozzle #i.

A latch signal LAT is inputted into the group of latch circuits 423 and the data selector 424. A change signal CH is inputted into the data selector 424. Each of the latch signal LAT and the change signal CH has a pulse that specifies a point in time (i.e., timing) at which the print signal PRT(i) should change.

Serial-to-parallel conversion processing is performed on the serial print signal PRT supplied to the head driving circuit 42. It is converted into the one hundred eighty 2-bit print signals PRT(i) as follows. The print signal PRT is inputted into the one hundred eighty first shift registers 421 first. Then, it is inputted into the one hundred eighty second shift registers 422. When the pulse of the latch signal LAT is inputted into the group of latch circuits 423, the group of latch circuits 423 latches the three hundred sixty data in the respective shift registers. When the pulse of the latch signal LAT is inputted into the group of latch circuits 423, it is inputted into the data selector 424, too. Upon receiving the input pulse of the latch signal LAT, the data selector 424 is set into its initial state. The data selector 424 in the initial state selects data stored in the first shift registers 421 before latching from the group of latch circuits 423 and outputs them as the print signals PRT(i) to the switches SW(i), respectively. Next, in response to the pulse of the change signal CH, the data selector 424 selects data stored in the second shift registers 422 before latching from the group of latch circuits 423 and outputs them as the print signals PRT(i) to the switches SW(i), respectively. In this way, the serial print signal PRT is converted into the one hundred eighty 2-bit data as a result of the serial-to-parallel conversion.

When the level of the print signal PRT(i) is “1”, the switch SW(i) allows the driving pulse of the original driving signal ODRV to pass therethrough, thereby outputting the driving signal DRV(i) having the corresponding pulse. When the level of the print signal PRT(i) is “0”, the switch SW(i) cuts off the driving pulse of the original driving signal ODRV so that it does not pass therethrough. Consequently, when the print signal PRT(i) indicates “11”, both the first driving pulse W1 and the second driving pulse W2 are inputted into the piezoelectric element PZT(i). Therefore, in such a case, a large dot is formed. When the print signal PRT(i) indicates “10”, the first driving pulse W1 is inputted into the piezoelectric element PRT(i). Therefore, in such a case, a middle-size dot is formed. When the print signal PRT(i) indicates “01”, the second driving pulse W2 is inputted into the piezoelectric element PZT(i). Therefore, in such a case, a small dot is formed. That is, in any of these cases, a dot having a size corresponding to the bit representation of the print signal PRT(i) is formed on a sheet of paper. When the print signal PRT(i) indicates “00”, no driving pulse is inputted into the piezoelectric element PZT(i). Therefore, no dot is formed in such a case.

### Printing Method

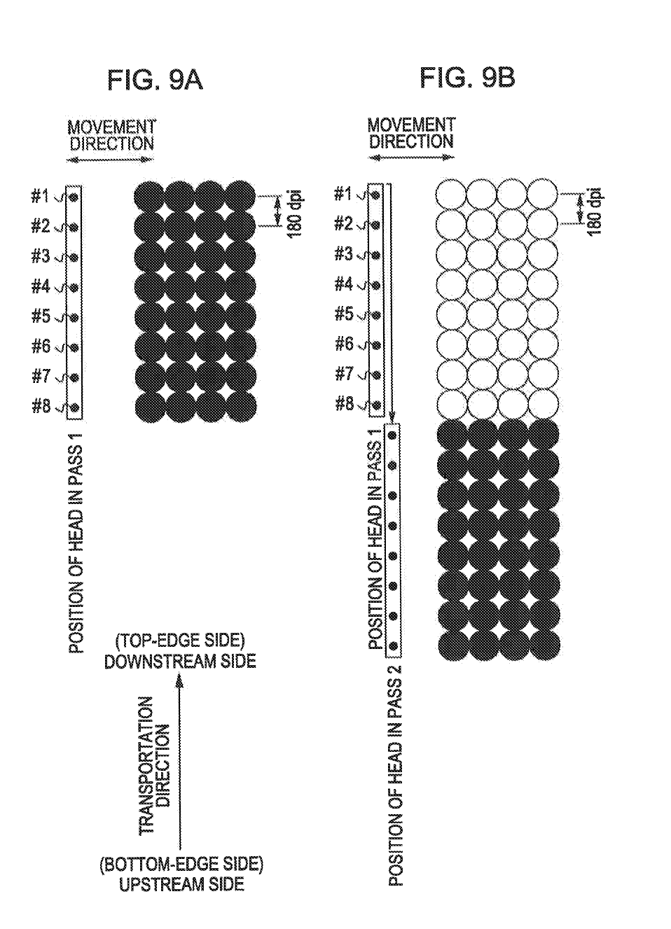

Each of FIGS. 9A and 9B is a diagram that schematically illustrates a band printing method as an example of various printing methods. FIG. 9A illustrates the position of a head (or the positions of nozzles) in a certain pass and the formation of dots therein. FIG. 9B illustrates the position of the head in the next pass and the formation of dots therein.

To simplify explanation, one of the plural nozzle lines only is illustrated therein. In addition, the number of nozzles that belong to the nozzle line is reduced for the same purpose. The number of nozzles belonging to the nozzle line is assumed to be eight in the illustrated example. To simplify illustration, it is shown in FIGS. 9A and 9B as if the head (or the nozzle line) moved with respect to paper. Note that, however, these drawings show the positions of the head and the paper relative to each other; that is, it is the paper that actually moves (i.e., is actually transported) in the transportation direction. Moreover, though it is shown as if several dots (shown as circles in FIGS. 9A and 9B) only were formed for each of the nozzles to simplify illustration, note that many dots are actually formed in a line in the movement direction for each of the nozzles because ink droplets are discharged intermittently from the nozzle that is moved in the movement direction. Such a line of dots is referred to as a raster line. The dots shown as black circles denote dots formed in the last pass. The dots shown as white circles denote dots formed in the pass before last. Herein, the term “pass” means the operation of discharging ink from nozzles during movement to form dots (which corresponds to liquid discharging operation). The pass and the operation of transporting a sheet of paper in the transportation direction (transporting operation) are repeated alternately.

The term “band printing” means a printing method according to which the pitch of nozzles is equal to dot interval, and in addition, a continuous raster line is formed in a single execution of pass. That is, in band printing, a band-like piece of an image is formed as a result of the execution of pass once, where the width of the band-like piece of the image corresponds to the length of a nozzle line. In the transporting operation, which is performed each between a pass and the next pass, a sheet of paper is transported by a distance that corresponds to the length of the nozzle line. In the illustrated example, the paper is transported by 8D. Since the pass and the transporting operation are repeated alternately, the band-like pieces of the image are joined to one another. A print image is formed in this way. As explained above, in band printing, the dot interval D in the transportation direction is equal to the nozzle pitch, which is 180 dpi in the present embodiment of the invention. In addition, in the transporting operation of band printing, a target medium is transported by transportation amount corresponding to the length of a nozzle line in the transportation direction. For example, if the number of nozzles is 180, the transportation amount is 180D. Furthermore, in band printing, a raster line that is formed by the first nozzle from the downstream end of a nozzle line in the transportation direction is always adjacent to a raster line that is formed by the first nozzle from the upstream end of the nozzle line in the transportation direction.

### Correction of Ink-Landing Position

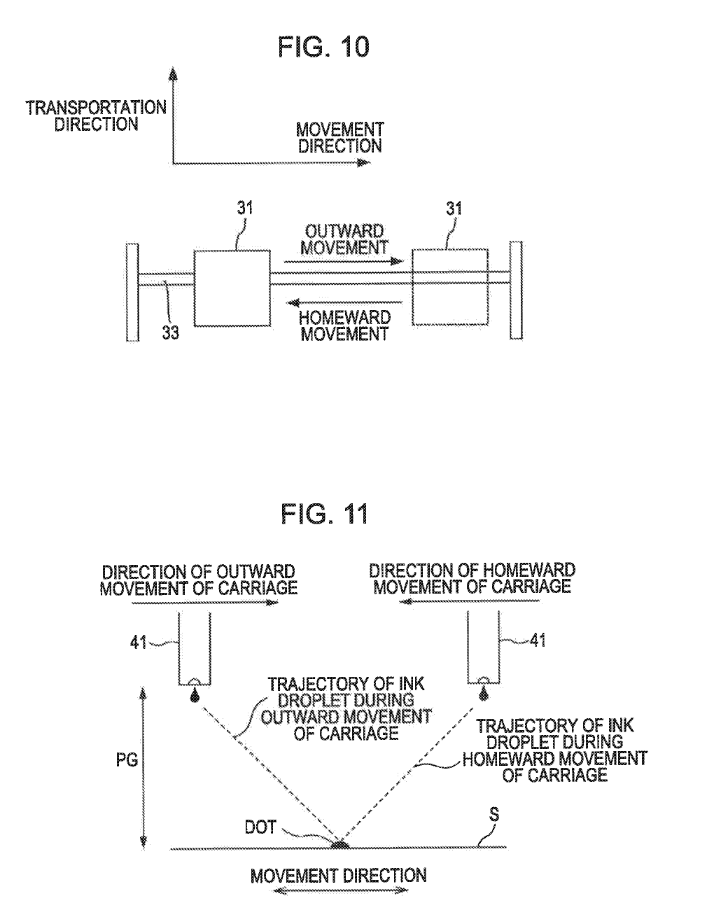

FIG. 10 is a diagram that schematically illustrates an example of the movement direction when the carriage 31 travels during its outbound movement and homebound movement. The printer 1 performs so-called “bidirectional printing” according to which ink is discharged for printing both during the outward movement of the carriage 31 and the homeward movement thereof while reciprocating the carriage 31 along the carriage shaft 33 as illustrated in FIG. 10. When such bidirectional printing is performed, there occurs a displacement (i.e., shift) in the landing position of ink during the outward movement of the carriage 31 and the landing position of ink during the homeward movement thereof. The shift in position is explained in detail below.

FIG. 11 is a diagram that schematically illustrates an example of the ink-discharging timing of the head 41 during outward and homeward movement. The diagram is a view taken along the transportation direction. Therefore, the direction perpendicular to the sheet face of FIG. 11 corresponds to the transportation direction. The leftward/rightward direction therein corresponds to the movement direction. The head 41 and a sheet of paper S are set opposite to each other with a gap PG therebetween.

An ink droplet Ip discharged from the head 41 during the movement of the carriage 31 moves in the air toward the surface of the paper S, which faces the head 41 with the gap PG therebetween. The gap GP defines the vertical-line distance between the head 41 and the paper S. When the ink droplet Ip moves in the air toward the surface of the paper S, the force of inertia acts thereon. Therefore, the ink droplet Ip moves in the air while gradually shifting its position in the direction of the movement of the carriage 31 (i.e., the movement direction) before it lands on the surface of the paper S. For this reason, the position where the discharged ink droplet Ip actually lands on the surface of the paper S is shifted (i.e., displaced) from the position where it is released for discharging. To ensure that the ink droplet Ip actually lands at a target position, it is necessary to release the ink droplet Ip before the position of the discharging nozzle of the moving head 41 in the movement direction reaches the target position in the movement direction. The same holds true for homeward movement. Since the ink droplet Ip is discharged from the head 41 during the movement of the carriage 31, to ensure that the ink droplet Ip actually lands at the target position, it is necessary to release the ink droplet Ip before the position of the discharging nozzle of the moving head 41 in the movement direction reaches the target position in the movement direction.

However, since the direction of the outward movement of the carriage 31 is opposite to the direction of the homeward movement thereof, even when it is desired that the ink droplet Ip should land on the same target position, the timing of discharging the ink droplet Ip during the outward movement differs from the timing of discharging the ink droplet Ip during the homeward movement. To overcome the problem of such a displacement in the landing position of ink during outward movement and the landing position of ink during homeward movement, the printer 1 according to the present embodiment of the invention performs correction while shifting the timing of discharging the ink droplet Ip during the outward and homeward movement. The correction is performed on the basis of a preset correction value. In the present embodiment of the invention, the correction value is stored in the memory 63 of the printer 1. However, the scope of the invention is not limited to such an exemplary configuration. For example, the correction value may be sent from a host machine for printing. The correction may be hereinafter referred to as “Bi-d correction”.

### Configuration of Platen

There is a printing method called as “borderless printing”. In borderless printing, dots are formed while leaving no white spaces around the edges of a sheet of paper. Borderless printing makes it possible to print an image by utilizing the entire sheet of paper for a printout.

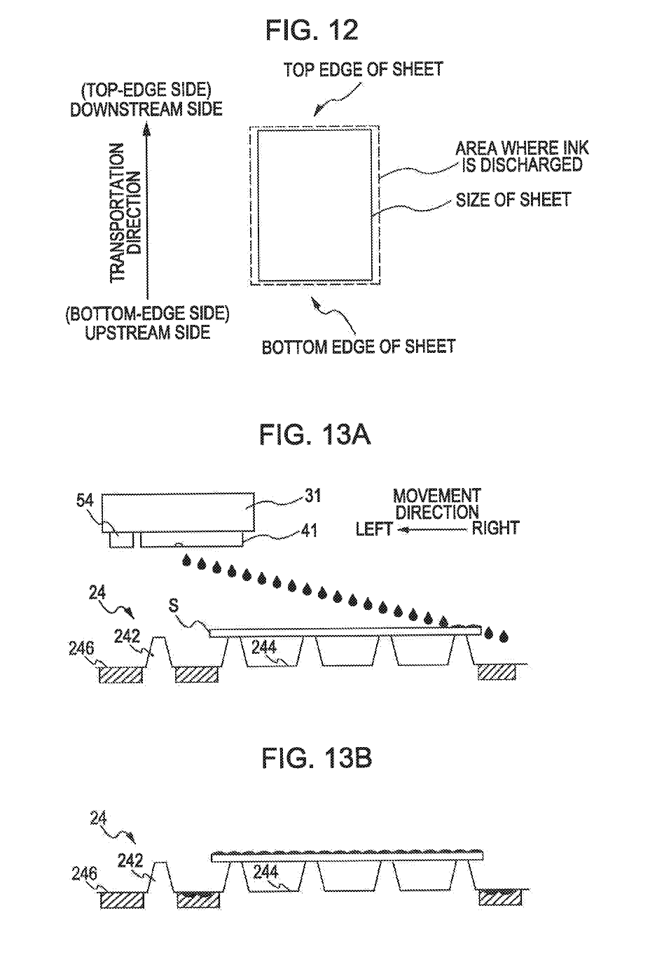

FIG. 12 is a diagram that schematically illustrates an example of borderless printing. In FIG. 12, the inner rectangle shown by a solid line (box) represents the size of a sheet of paper S. The outer rectangle shown by a dotted line represents the area where ink is discharged. It is possible to print an image on the sheet of paper S without leaving white spaces around the edges thereof by discharging ink onto the area that is wider than, and includes, the entire area of the paper S. However, since the entire area of the paper S (shown by the solid box) is located inside the area where ink is discharged (shown by the dotted box), some ink does not land on the surface of the paper S when borderless printing is performed (hereinafter referred to as “ink landing on the non-paper area outside the paper area” or simply as “non-paper-area ink”). If the non-paper-area ink landed directly on the surface of the platen 24, when the next sheet of paper is transported thereon, the back of the sheet would be stained thereby. To avoid the back of the sheet from being stained, in a printer that performs borderless printing, projections and recesses are formed on/in the platen 24. The recesses collect the non-paper-area ink.

FIG. 13A is a diagram that schematically illustrates an example of the discharging of ink when borderless printing is performed. FIG. 13B is a diagram that schematically illustrates an example of the landing of the discharged ink when borderless printing is performed. Each of FIGS. 13A and 13B shows borderless printing in which dots are formed without leaving white spaces around the left and right edges of a sheet of paper (i.e., the edges in the movement direction). Each of FIGS. 13A and 13B is a view taken along the transportation direction. To simplify explanation, one of the plural nozzle lines only is illustrated therein.

The platen 24 of the printer 1 according to the present embodiment of the invention has projections (which may be referred to as “convex portions” or “ribs”) 242 and recesses (which may be referred to as “concave portions”) 244. In addition, the platen 24 includes an absorbent member 246.

The projection 242, which corresponds to a supporting member, is a member that supports a sheet of paper in contact therewith. The plurality of projections 242 is arranged in the movement direction. The projections 242 are formed to ensure that the sheet of paper supported thereby is not in contact with the recesses 244. In addition, the projections 242 are arranged in such a manner that none of them is located at the position of the left/right edge of a sheet of paper having standard size.

The recesses 244 are concaves formed in the platen 24. Since the recesses 244 are recessed relative to the projections 242 as their name indicates, even when the recesses 244 are stained by ink, the back of a sheet of paper is not stained thereby. Therefore, even when ink is discharged onto the area extending across the entire width of a sheet of paper during borderless printing, ink landing on the non-paper area outside the paper area (the recesses 244) does not stain the back of the sheet.

The absorbent member 246 is a member for absorbing ink. The absorbent member 246 is made of an absorbent material such as sponge or the like. The absorbent member 246 is provided in the recesses 244. The absorbent member 246 absorbs, the non-paper-area ink, which lands in the recesses 244 when borderless printing is performed. Since the absorbent member 246 absorbs the non-paper-area ink, it is possible to prevent the spattering thereof at and from the non-paper area. The printer 1 can perform printing on various sheets of paper having different widths. Therefore, the absorbent member 246 is provided at the non-paper area that is determined depending on the width of paper having each standard size available for printing.

As illustrated in FIGS. 13A and 13B, it is possible to print an image while leaving no white spaces around the left and right edges of a sheet of paper S by discharging ink onto the area extending across the entire width of the paper S. In addition, since the non-paper-area ink lands on the absorbent member 246 provided in the recesses 244, it is possible to avoid the back of the paper S from being stained by the non-paper-area ink.

In a structure in which the platen 24 has the projections 242, which support a sheet of paper S, and recesses 244 as explained above, it is likely that a cockling phenomenon will occur as a result of the formation of dots on the surface of the paper S. The cockling phenomenon is explained below.

### Cackling Phenomenon

Generally, a sheet of paper S absorbs ink that has landed on the surface thereof. The paper S swells by absorbing the ink to become corrugated. The undulations extend in the movement direction. Such a phenomenon is called as a cockling phenomenon.

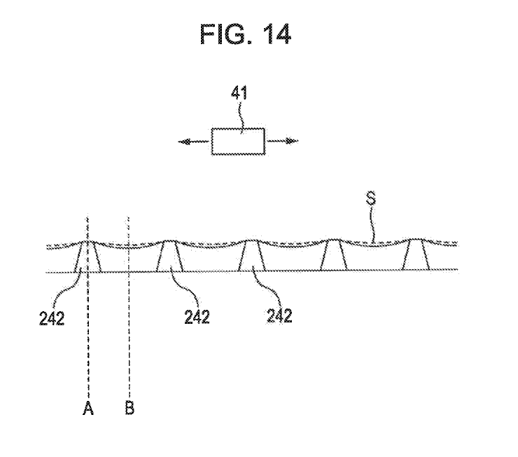

FIG. 14 is a diagram that schematically illustrates an example of the states of paper S when a cockling phenomenon has occurred. In FIG. 14, a broken line curve represents the state of the paper S when print duty is small, whereas a solid line curve represents the state of the paper S when print duty is large. The term “print duty” means dot-formation percentage, that is, the ratio of the number of dots formed actually to the total number of dots that can be formed when a pass is executed.

As illustrated therein, the factor of undulation (i.e., flexion rate) differs depending on print duty. Specifically, flexion rate increases as print duty increases. When a sheet of paper S has undulations due to the occurrence of a cockling phenomenon (hereinafter may be simply referred to as “cockling”), the clearance between the head 41 and the paper S (i.e., gap) differs depending on the position in the movement direction. Therefore, a shift in the landing position of ink occurs depending on the position in the movement direction.

### Bi-d Correction

### COMPARATIVE EXAMPLE

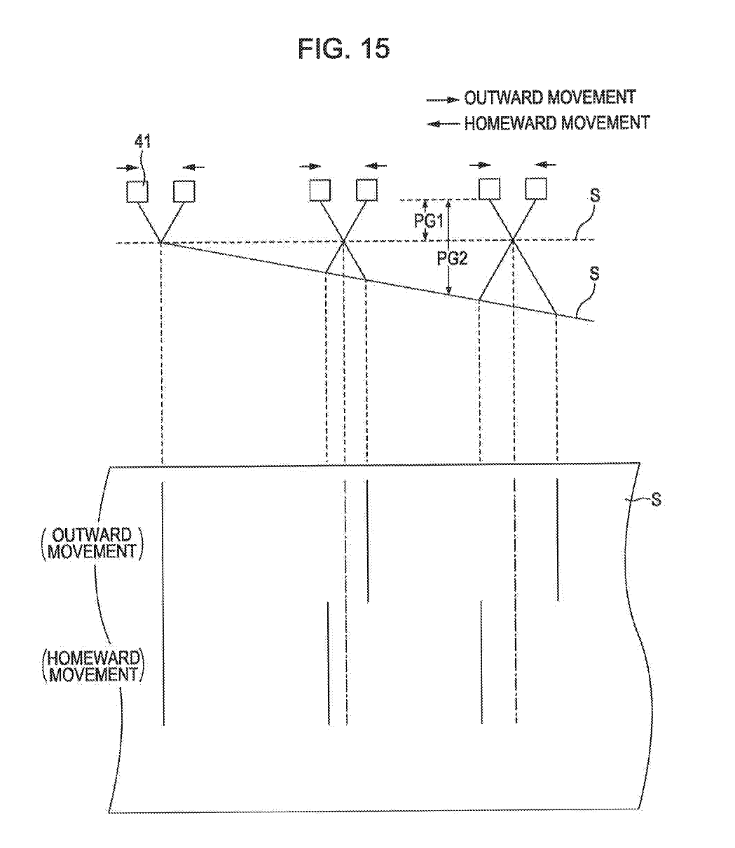

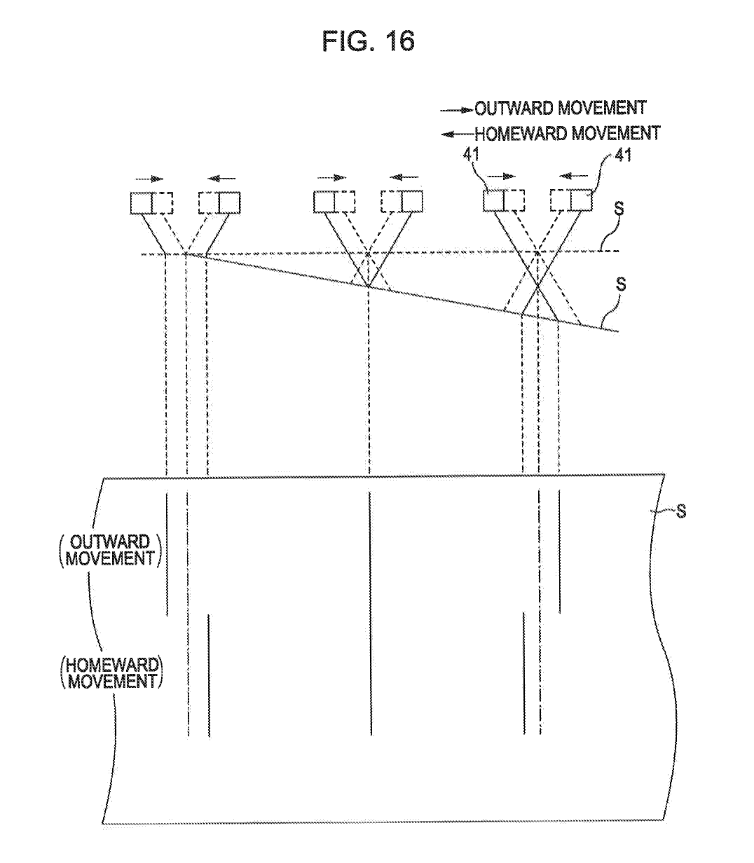

FIG. 15 is a diagram that schematically illustrates Bi-d correction according to a comparative example. The state of a sheet of paper S shown by a broken line in FIG. 15 corresponds to a state in which no cockling has occurred. In such a state, the gap is constant (denoted as PG1) irrespective of the position of the paper S (position in the movement direction). The state of the paper S shown by a solid line in FIG. 15 corresponds to a state in which cockling has occurred. In such a state, the gap differs (denoted as PG2) depending on the position in the movement direction. The left part of FIG. 15 corresponds to a peak of undulations caused by cockling, which is the position (e.g., center) of the projection 242, for example, the position A shown in FIG. 14. The right part of FIG. 15 corresponds to a valley of undulations caused by cockling, which is the position between two of the projections 242 that are arranged adjacent to each other, for example, the position B shown in FIG. 14. The center part of FIG. 15 corresponds to the midpoint between the peak and the valley, for example, the center between the positions A and B shown in FIG. 14.

The lower part of FIG. 15 shows a ruled line(s) that is outputted when printing is performed by means of a bidirectional band printing method. The ruled line extends in the transportation direction. The ruled line shown by an alternate long and short dash line in FIG. 15 represents a line printed in a state in which no cockling has occurred. The ruled line shown by a solid line in FIG. 15 represents a line printed in a state in which cockling has occurred.

It is assumed herein as well as in the present embodiment of the invention that the correction value used for Bi-d correction is preset for the gap PG1. Therefore, if no cockling has occurred, the timing of discharging ink from the head 41 during outward and homeward movement is corrected by means of the value, resulting in the landing of the ink at the target position. Thus, as shown by an alternate long and short dash line therein, there occurs no shift in position at the (each) junction of one part of a ruled line that is drawn during outward movement and the other part thereof that is drawn during homeward movement.

However, if the sheet of paper S has undulations due to the occurrence of cockling, the gap PG2 changes depending on the position in the movement direction. Specifically, for example, the gap PG2 is relatively small at a peak of undulations caused by cockling. The gap PG2 is relatively large at a valley of undulations caused by cockling. In such a case, as the gap PG2 increases, a shift in position at the junction of one part of a ruled line that is drawn during outward movement and the other part thereof that is drawn during homeward movement increases. That is, as the flexion rate of the sheet of paper S increases, a shift in position at the junction of one part of a ruled line and the other part thereof increases when the ruled line is printed. As described above, cockling causes a shift in the landing position of ink in outward and homeward movement. In particular, as illustrated therein, when a ruled line is printed along the transportation direction by using a bidirectional band printing method, the shift is conspicuous because one part of the ruled line and the other part thereof are displaced from each other at its joint region. In view of the above, in the present embodiment of the invention, the correction value used for Bi-d correction is adjusted depending on cockling condition, in other words, depending on print duty. By this means, it is possible to substantially reduce a shift in position at the joint region of a ruled line.

### Present Embodiment

FIG. 16 is a diagram that schematically illustrates an example of Bi-d correction according to the present embodiment of the invention. In FIG. 16, each head 41 shown by a broken line (box) indicates a position where the head discharges ink in a case where no cockling has occurred. In such a case, the ink-discharging position is the same as that of normal Bi-d correction (refer to FIG. 15). Each head 41 shown by a solid line indicates an ink-discharging position in a case where cockling has occurred. As will be understood from the drawing, in the present embodiment of the invention, the timing of discharging ink (i.e., the Bi-d correction value) is adjusted depending on the state of a sheet of paper S (i.e., cockling condition) when printing a ruled line. The state of cockling is determined depending on print duty as explained earlier. That is, in the present embodiment of the invention, the correction value used for Bi-d correction (i.e., the timing of discharging ink from the head 41) is changed in accordance with the duty of printing that was performed before the printing of a ruled line.

As illustrated in FIG. 16, in the present embodiment of the invention, when print duty is large, the correction value used for Bi-d correction is adjusted to ensure that a shift in the landing position of ink in outward and homeward movement (positional difference therebetween) is minimized at the midpoint between a peak and a valley of undulations caused by cockling, for example, the center between the positions A and B shown in FIG. 14. By this means, it is possible to eliminate a poorly joined region, that is, the junction of a ruled line where one part thereof and the other part thereof are significantly shifted in position from each other as shown at the right part of FIG. 15, which shows a comparative example. Therefore, with the present embodiment of the invention, it is possible to make a shift in position at the junction. of one part of a ruled line and the other part thereof less conspicuous, thereby enhancing print quality as a whole.

In bidirectional printing, since the direction of outward movement is opposite to the direction of homeward movement, when dots are formed while discharging ink of two or more colors, the sequential order of the discharging of the ink in outward pass is opposite to the sequential order of the discharging of the ink in homeward pass. A more detailed explanation of the above is given below. The arrangement of nozzle lines shown in FIG. 6 is taken as an example. Let us call the rightward movement of the head 41 in FIG. 6 outward movement. Let us call the leftward movement of the head 41 in FIG. 6 homeward movement. In outward pass, yellow, magenta, cyan, and black ink is sequentially discharged from the respective nozzle lines in this order, that is, starting from the downstream side in the movement direction (i.e., right side in FIG. 6). In homeward pass, black, cyan, magenta, and yellow ink is sequentially discharged from the respective nozzle lines in this order, that is, starting from the downstream side in the movement direction (i.e., left side in FIG. 6). For this reason, for example, when black ink is used to print a black ruled line, the state of a sheet of paper S (i.e., cockling condition) at the time of the discharging of the black ink during outward movement is different from the state of the paper S at the time of the discharging of the black ink during homeward movement.

In view of the above, in the present embodiment of the invention, when a ruled line is printed along the transportation direction with the use of a certain nozzle line (e.g., the black ink nozzle line K), Bi-d correction is performed (i.e., correction value is adjusted) for the nozzle line used for printing the ruled line in accordance with the duty of printing performed with the use of another nozzle line or other or the other nozzle lines located downstream of the nozzle line used for printing the ruled line in the movement direction in each pass.

### Print Processing

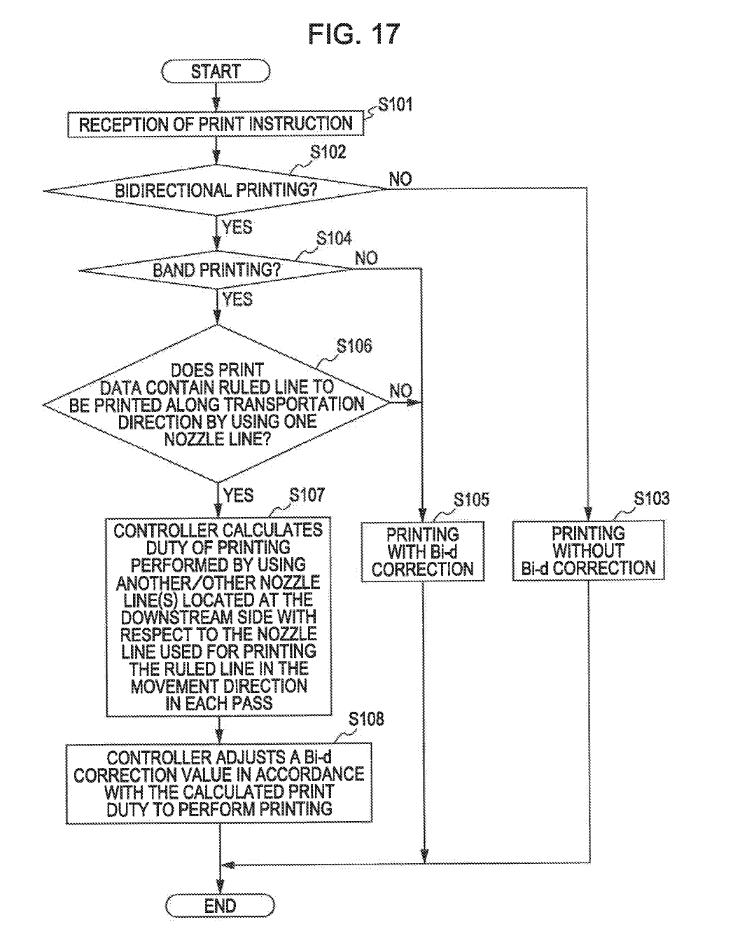

FIG. 17 is a flowchart that schematically illustrates an example of the flow of processing for printing according to the first embodiment of the invention. The Bi-d correction value has been set in advance by printing a test pattern and reading it in a state free from cockling. The preset Bi-d correction value is stored in the memory 63 of the printer 1. Besides the preset Bi-d correction value, a table is stored in the memory 63. The table contains preset relationships between print duties and adjustment values for the Bi-d correction value.

Upon receiving a print instruction from the computer 110 (S101), the controller 60 judges whether printing should be performed by means of a bidirectional printing method or not on the basis of a command contained in print data (S102). If it is judged that the command is not a bidirectional print command (S102: NO), the controller 60 performs control processing for unidirectional printing on the basis of the print data (S103). That is, Bi-d correction is skipped in this case.

If it is judged that bidirectional printing should be performed (S102: YES), the controller 60 further judges whether printing should be performed by means of a band printing method or not on the basis of the command contained in the print data (S104). If it is judged that the command is not a band print command (S104: NO), for example, if the command is an interlace print command or an overlap print command, the controller 60 performs control processing for printing by using the original Bi-d correction value stored in the memory 63 without any adjustment (S105). The reason why the original Bi-d correction value is used is that, even when there occurs a shift in the landing position of ink in outward and homeward movement in interlace printing, overlap printing, or the like, the shift is less conspicuous in comparison with that of band printing.

If it is judged that the command is a band print command (S104: YES), the controller 60 further judges whether the print data contains a ruled line that is to be printed along the transportation direction or not (S106). If it is judged that the print data does not contain a ruled line that is to be printed along the transportation direction (S106: NO), the controller 60 performs control processing for printing by using the original Bi-d correction value without any adjustment (S105).

If it is judged that the print data contains a ruled line that is to be printed along the transportation direction (S106: YES), the controller 60 calculates the duty of printing performed with the use of another nozzle line or other or the other nozzle lines located at the downstream side with respect to the nozzle line used for printing the ruled line in the movement direction in each of outward and homeward passes (S107). Thereafter, the controller 60 looks up the table stored in the memory 63, that is, the table containing preset relationships between print duties and adjustment values, and adjusts the Bi-d correction value in accordance with the calculated print duty to perform printing (S108).

For example, when the black ink nozzle line K is used to print a black ruled line, the black ink nozzle line K is the first nozzle line from the upstream edge of the head 41 (i.e., the most upstream nozzle line) in the movement direction in outward pass. Therefore, the correction value used for Bi-d correction is adjusted in accordance with the duty of printing performed with the use of the other nozzle lines. In the adjustment of the correction value, the larger the calculated print duty, the earlier the timing of discharging ink from the black ink nozzle line K. By this means, it is possible to ensure that a shift from the target landing position is small.

On the other hand, the black ink nozzle line K is the first nozzle line from the downstream edge of the head 41 (i.e., the most downstream nozzle line) in the movement direction in homeward pass. That is, the print duty calculated in S107 is zero. Since black ink is discharged first onto a sheet of paper S in homeward pass, it is not necessary to take cockling into consideration. Thus, the correction value used for Bi-d correction is not adjusted actually.

As explained above, in the present embodiment of the invention, when a ruled line is printed along the transportation direction with the use of a certain nozzle line, the correction value used for Bi-d correction is adjusted for the nozzle line used for printing the ruled line in accordance with the duty of printing performed with the use of another nozzle line or other or the other nozzle lines located at the downstream side with respect to, that is, downstream in comparison with the location of, the nozzle line used for printing the ruled line in the movement direction in each pass. With such adjustment, it is possible to correct a position where ink lands depending on the state of a sheet of paper S (i.e., cockling condition) when printing a ruled line. Therefore, a shift in the landing position of ink in outward pass and homeward pass is made significantly smaller. Thus, a shift in position at the junction of one part of a ruled line and the other part thereof can be reduced.

In addition, in the present embodiment of the invention, the correction value used for Bi-d correction is adjusted to ensure that a shift in the landing position of ink in outward and homeward movement is minimized at the midpoint between a valley of undulations, which is the position between two of the projections 242 that are arranged adjacent to each other (e.g., the position B), and a peak of undulations, which is the position of the projection 242 (e.g., the position A). Thus, it is possible to make the shift in position inconspicuous.

In the present embodiment of the invention, it is explained that the platen 24 has the projections 242 and recesses 244. If the platen 24 does not have the projections 242 and recesses 244, a sheet of paper sometimes becomes partially raised as a result of printing. In such a configuration, the gap PG decreases as print duty increases. As done in the above embodiment of the invention, in such a configuration, it is possible to reduce a shift in position at the junction of one part of a ruled line and the other part thereof by adjusting the correction value used for Bi-d correction in accordance with the duty of printing performed before the printing of the ruled line when executing each pass.

### Second Embodiment

In the first embodiment of the invention, the Bi-d correction value is adjusted in accordance with print duty in each pass. In contrast, in the second embodiment of the invention, the Bi-d correction value is adjusted in accordance with print duty at a partial area where a ruled line is to be printed in the entire area between the projections 242 arranged adjacent to one another in the movement direction. Since the configuration of a printer according to the second embodiment of the invention is the same as that of the first embodiment of the invention, it is not explained here.

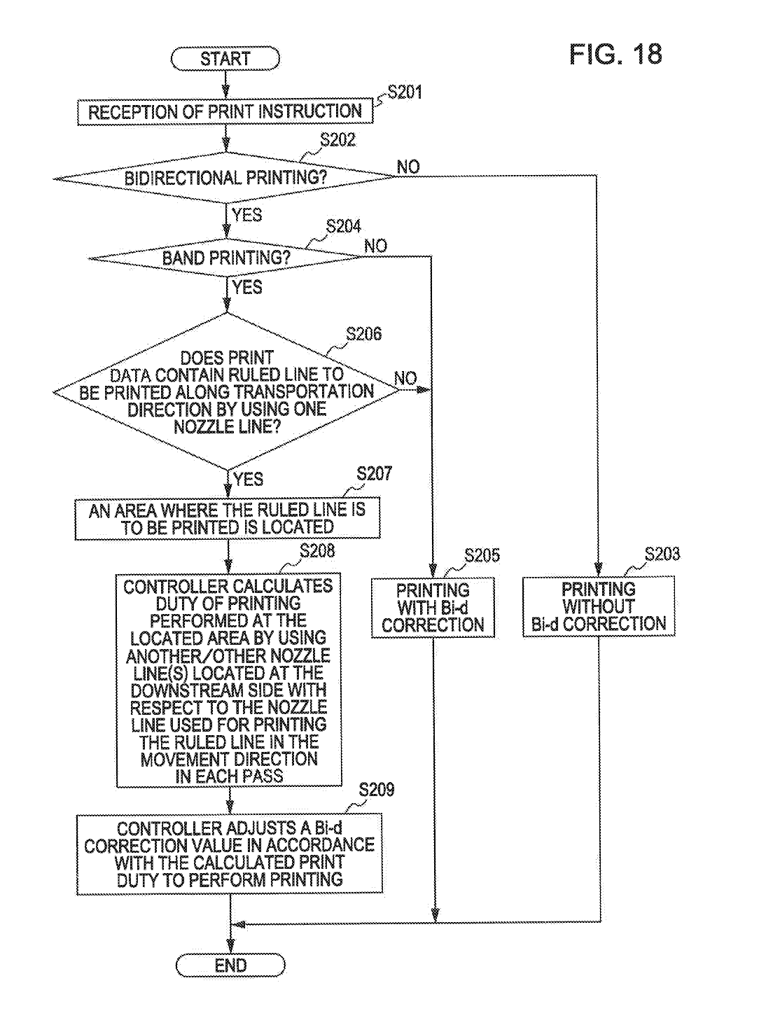

FIG. 18 is a flowchart that schematically illustrates an example of the flow of processing for printing according to the second embodiment of the invention. The steps S201 to S206 in FIG. 18 correspond to the steps S101 to S106 in FIG. 17, respectively. Therefore, these steps are not explained here.

If it is judged that print data contains a ruled line that is to be printed along the transportation direction with the use of a certain nozzle line (S206: YES), the controller 60 locates an area where the ruled line is to be printed between the projections 242 (S207). Then, the controller 60 calculates the duty of printing performed at the located area with the use of another nozzle line or other or the other nozzle lines located at the downstream side with respect to the nozzle line used for printing the ruled line in the movement direction in each pass (S208). That is, the controller 60 calculates the ratio of the number of dots formed actually at the located area to the total number of dots that can be formed at the located area when a pass is executed. Thereafter, the controller 60 looks up the table and adjusts the Bi-d correction value in accordance with the calculated print duty to perform printing (S209).

The adjustment of the correction value used for Bi-d correction in the second embodiment of the invention is similar to that of the first embodiment of the invention. Specifically, the correction value is adjusted to ensure that a shift in the landing position of ink in outward and homeward movement is minimized at the midpoint between the center of the located area in the movement direction (which corresponds to the position B shown in FIG. 14) and an end of the located area in the movement direction (which corresponds to the position A shown in FIG. 14). By this means, it is possible to make the shift in position inconspicuous.

As explained above, in the second embodiment of the invention, a partial area where a ruled line is to be printed in the entire area between the projections 242 arranged adjacent to one another in the movement direction is located; and in addition, Bi-d correction is performed in accordance with the duty of printing performed at the located area with the use of another nozzle line or other or the other nozzle lines located at the downstream side with respect to the nozzle line used for printing the ruled line in the movement direction. In the present embodiment of the invention, when the correction value used for Bi-d correction is adjusted, the state of a sheet of paper S (i.e., cockling condition) at the partial area where the ruled line is to be printed will be reflected for greater accuracy in correction. Thus, it is possible to further reduce a shift in position at the junction of one part of the ruled line and the other part thereof.

### Other Embodiments

Although the technical concept of the present invention is explained above with the disclosure of exemplary embodiments with a printer taken as an example, the specific embodiments are provided solely for the purpose of facilitating the understanding of the invention. It should not be interpreted that the above embodiments are intended to limit the scope of the invention. Needless to say, the invention may be modified, altered, changed, adapted, and/or improved within a range not departing from the gist and/or spirit of the invention apprehended by a person skilled in the art from explicit and implicit description made herein, where such a modification, an alteration, a change, an adaptation, and/or an improvement is also covered by the scope of the appended claims. It is the intention of the inventor/applicant that the scope of the invention covers any equivalents thereof. As specific examples, the following variations are encompassed within the scope of the invention.

### Liquid Discharging Apparatus

In the foregoing embodiments of the invention, an ink-jet printer is taken as an example of a liquid discharging apparatus according to an aspect of the invention. However, the scope of the invention is not limited to such a specific example. The invention is also applicable to, and thus can be embodied as, a variety of liquid discharging apparatuses that discharge (or eject) a variety of liquid (or fluid), which is in no case limited to ink. For example, it may discharge liquid in which particles of a functional material(s) is dispersed. As another example, it may discharge a gel fluid. For example, a technique that is the same as or similar to the liquid discharging technique disclosed in the foregoing embodiments of the invention may be applied to various kinds of apparatuses employing an ink-jet discharging scheme, including but not limited to, a color filter manufacturing apparatus, a dyeing apparatus, a micro-fabrication/micro-machining apparatus, a semiconductor manufacturing apparatus, a surface treatment apparatus, a three-dimensional (3D) modeling apparatus, an aerification/gasification apparatus, an organic electroluminescence (EL) manufacturing apparatus (in particular, a polymer EL manufacturing apparatus), a display manufacturing apparatus, a film deposition apparatus, and a DNA chip manufacturing apparatus. In addition to a variety of apparatuses enumerated above, the scope of the invention encompasses methods and manufacturing methods corresponding to these apparatuses.

### Ink

In the foregoing embodiments of the invention, the ink discharged from the nozzles of a printer may be water-based ink or oil-based ink. Liquid discharged from nozzles is not limited to ink. For example, liquid that contains a metal material, an organic material (in particular, a high polymeric material), a magnetic material, a conducting material, a wiring material, a film-forming material, electronic ink, working liquid, DNA solution, or the like (including water) may be discharged from nozzles.

### Piezoelectric Element

In the foregoing embodiments of the invention, piezoelectric elements are used for discharging ink. However, the method for discharging liquid is not limited to such a piezoelectric scheme. An alternative method such as, for example, a thermal method that utilizes bubbles produced in nozzles due to heat may be used.

What is claimed is:

1. A liquid discharging apparatus comprising:
a transporting mechanism that transports a target medium in a transportation direction;
a plurality of nozzle lines each of which is made up of a plurality of nozzles aligned in the transportation direction, the plurality of nozzle lines being arranged adjacent to one another in a movement direction, which is orthogonal to, or intersects with, the transportation direction;
a moving mechanism that moves the plurality of nozzle lines in the movement direction; and
a controller that performs control processing for repeating liquid discharging operation and transporting operation,
wherein the liquid discharging operation is operation for discharging liquid from each of the nozzle lines that are being moved bi-directionally by the moving mechanism during outward and homeward movement in the movement direction,
the transporting operation is operation for transporting the target medium by the transporting mechanism in the transportation direction, and
when a ruled line is printed along the transportation direction with the use of a certain nozzle line in a certain liquid discharging operation, timing of discharging the liquid from the certain nozzle line in the certain liquid discharging operation is corrected in accordance with duty of printing performed with the use of another nozzle line or other or the other nozzle lines located at a downstream side with respect to the certain nozzle line in the movement direction.

2. The liquid discharging apparatus according to claim 1, further comprising a plurality of supporting members that is arranged in the movement direction for supporting the target medium, wherein the controller corrects the timing of discharging the liquid to ensure that a positional difference between a position where the liquid discharged in the liquid discharging operation during the outward movement and a position where the liquid discharged in the liquid discharging operation during the homeward movement is minimized at a midpoint between the center of an area between the neighboring supporting members and an end of the area in the movement direction.

3. A liquid discharging apparatus comprising:
a transporting mechanism that transports a target medium in a transportation direction;
a plurality of nozzle lines each of which is made up of a plurality of nozzles aligned in the transportation direction, the plurality of nozzle lines being arranged adjacent to one another in a movement direction, which is orthogonal to, or intersects with, the transportation direction;
a moving mechanism that moves the plurality of nozzle lines in the movement direction;
a plurality of supporting members that is arranged in the movement direction for supporting the target medium; and
a controller that performs control processing for repeating liquid discharging operation and transporting operation,
wherein the liquid discharging operation is operation for discharging liquid from each of the nozzle lines that are being moved bi-directionally by the moving mechanism during outward and homeward movement in the movement direction,
the transporting operation is operation for transporting the target medium by the transporting mechanism in the transportation direction, and
when a ruled line is printed along the transportation direction with the use of a certain nozzle line in a certain liquid discharging operation, timing of discharging the liquid from the certain nozzle line in the certain liquid discharging operation is corrected in accordance with duty of printing performed at an area between the supporting members where the ruled line is to be located with the use of another nozzle line or other or the other nozzle lines located at a downstream side with respect to the certain nozzle line in the movement direction.

4. The liquid discharging apparatus according to claim 3, wherein the controller corrects the timing of discharging the liquid to ensure that a positional difference between a position where the liquid discharged in the liquid discharging operation during the outward movement and a position where the liquid discharged in the liquid discharging operation during the homeward movement is minimized at a midpoint between the center and an end of the area in the movement direction.

5. A liquid discharging method using the liquid discharging apparatus according to claim 1, the liquid discharging method comprising:
correcting, when a ruled line is printed along the transportation direction with the use of a certain nozzle line in a certain liquid discharging operation, timing of discharging the liquid from the certain nozzle line in the certain liquid discharging operation in accordance with duty of printing performed with the use of another nozzle line or other or the other nozzle lines located at a downstream side with respect to the certain nozzle line in the movement direction; and
performing the liquid discharging operation on the basis of the corrected timing of discharging the liquid.

6. A liquid discharging method using the liquid discharging apparatus according to claim 3, the liquid discharging method comprising:
correcting, when a ruled line is printed along the transportation direction with the use of a certain nozzle line in a certain liquid discharging operation, timing of discharging the liquid from the certain nozzle line in the certain liquid discharging operation in accordance with duty of printing performed at an area between the supporting members where the ruled line is to be located with the use of another nozzle line or other or the other nozzle lines located at a downstream side with respect to the certain nozzle line in the movement direction; and
performing the liquid discharging operation on the basis of the corrected timing of discharging the liquid.
